(19) United States
(12) Patent Application Publication
(10) Pub. No.: US 2014/0071392 A1
(43) Pub. Date: Mar. 13, 2014

(54) INITIAL CONTACT CONTROL FOR LAMINATION

(71) Applicants: Der-Song Lin, Taipei (TW); Ralf Horstkemper, San Francisco, CA (US); Kuo-Hua Sung, Cupertino, CA (US)

(72) Inventors: Der-Song Lin, Taipei (TW); Ralf Horstkemper, San Francisco, CA (US); Kuo-Hua Sung, Cupertino, CA (US)

(73) Assignee: Apple Inc., Cupertino, CA (US)

(21) Appl. No.: 13/607,503

(22) Filed: Sep. 7, 2012

(51) Int. Cl. G02F 1/1339; B32B 37/12

(52) U.S. Cl. 349/153; 156/60; 156/350

(57) ABSTRACT

One embodiment of method and apparatus for laminating a first substrate to a second substrate can use a liquid optically clear adhesive to form an initial contact area in addition to bonding the first substrate to the second substrate. When either the first substrate or the second substrate is relatively clear, the initial contact area can help reduce the introduction of bubbles or voids into a lamination region between the two substrates. In another embodiment, selected regions of a substrate can be treated to enhance the flow of the liquid optically clear adhesive, which can also reduce the introduction of bubbles and voids into the lamination region.

### FIELD OF THE DESCRIBED EMBODIMENTS

The described embodiments relate generally to laminate bonding between two substrates and more particularly to laminate bonding two substrates with an optically clear adhesive when at least one of the substrates is relatively transparent.

### BACKGROUND

Substrates can be bonded together with a variety of adhesives and techniques. Some substrates can be more difficult to laminate, particularly when the substrates are clear and the lamination process can introduce bubbles or voids between the substrates.

In some applications, the lamination between a first substrate and a second substrate can be in a critical visible area of a product. An example of a critical visible area can be a display screen for a computing device. Display screens can include multiple substrates stacked in sequence, including items such as a liquid crystal display, one or more filters to modify the light to and from the liquid crystal display and a cover glass to provide protection to display components and provide the user with a finished surface. If a bubble or void exists in the lamination area between the cover glass and the liquid crystal display, a visible defect would present itself. If the visible defect was in a central region of the display, or if the visible defect was relatively large, or if there were a plurality of visible defects, then display functionality may be compromised since visible information can be distorted by the visible defects.

Therefore, what is desired is a reliable way to laminate a first substrate to a second substrate, and avoid introducing bubbles or voids between the substrate layers.

### SUMMARY OF THE DESCRIBED EMBODIMENTS

This paper describes various embodiments that relate to forming a lamination between a first and a second substrate with a liquid optically clear adhesive such that bubbles and voids are avoided in the lamination area.

In one embodiment, a method of laminating a first substrate to a second substrate with a liquid optically clear adhesive (LOCA) can include the steps of applying a uniform layer of LOCA on the first substrate, forming only one initial contact region with LOCA dispensed separately from the uniform layer of LOCA only on one edge of the second substrate, placing the initial contact region of LOCA in contact with the uniform LOCA layer and arranging the first substrate to bond with the second substrate.

A display assembly can include a first substrate, a board assembly that can include a liquid crystal display, where the board assembly is positioned under the first substrate, a layer of LOCA placed on the liquid crystal display and a single contact region of LOCA disposed on the first substrate where the first substrate is laminated to the liquid crystal display by first contacting the single contact region of LOCA with the layer of LOCA on the liquid crystal display.

A method for laminating a cover glass to a display with LOCA can include the steps of applying a uniform layer of LOCA onto the display, creating an initial contact region with LOCA on one edge of the display disposed over the layer of LOCA, placing one edge of the cover glass in contact with the initial contact region and forming a lamination by arranging the cover glass to be parallel with the display.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is an exploded view of a lamination assembly.

FIG. 2 shows an exploded view of one embodiment of a lamination assembly configured to control an initial LOCA contact area.

FIG. 3 shows an exploded view of another embodiment of a lamination assembly configured to control an initial LOCA contact area.

FIG. 4 shows yet another embodiment of a lamination assembly configured to control an initial LOCA contact area.

FIG. 5 shows still yet another embodiment of a lamination assembly configured to control an initial LOCA contact area.

FIG. 6 shows still another embodiment of a lamination assembly.

FIG. 7 shows an exploded view of a lamination assembly configured to receive a surface treatment to improve wettability of LOCA.

FIG. 8 is a flow chart of method steps for laminating a first substrate to a second substrate in accordance with one embodiment described in the specification.

FIG. 9 is a flow chart 900 of another embodiment of method steps for laminating a first substrate to a second substrate in accordance with one embodiment described in the specification.

FIG. 10 is a block diagram of an electronic device suitable for controlling some of the processes in the described embodiment.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

When laminating a first substrate to a second substrate, a bubble or a void can form in a lamination area particularly when the lamination adhesive is a liquid optically clear adhesive (LOCA). A LOCA can be selected when the lamination is positioned in a highly visible area, such as a display area for a computing device. For example, a cover glass acting as a first substrate can be laminated to a display acting as a second laminate to form a display assembly. Display assembly performance can be related to a clear and void free lamination. Laminated displays assemblies are used not only in computing devices, but also portable communication devices, media players, handheld global positioning systems and the like.

One way to help ensure a bubble free lamination is to control the initial contact between the first and the second substrate through the LOCA. Ideally the LOCA should be smooth and without waves as the LOCA is deposited onto one of the substrate surfaces. However, by controlling a first contact area between the LOCA and the substrates, the LOCA lamination area can be influenced so that bubbles are not trapped within the adhesive.

Controlling the initial contact area between the substrates can involve manipulating the LOCA in addition to the LOCA already used for lamination. Additional LOCA can be dispensed in particular area to help ensure a bubble free lamination. In another embodiment, initial contact can be controlled by slightly deforming at least one of the substrates to form the initial contact area.

Affinity between a liquid, such as a LOCA, and a solid, such as a substrate like glass can often be described as “wettability”. Those skilled in the art can appreciate that when a surface energy on a substrate is greater than a surface energy of the LOCA, then the LOCA can wet the substrate and flow more evenly and freely over the substrate. On the other hand, when the surface energy on the substrate is lower than the surface energy in the liquid, then the liquid does not wet the substrate well. Another way to help ensure a bubble free lamination addresses the surface energy on the substrates to help improve wettability and help the LOCA spread and flow evenly.

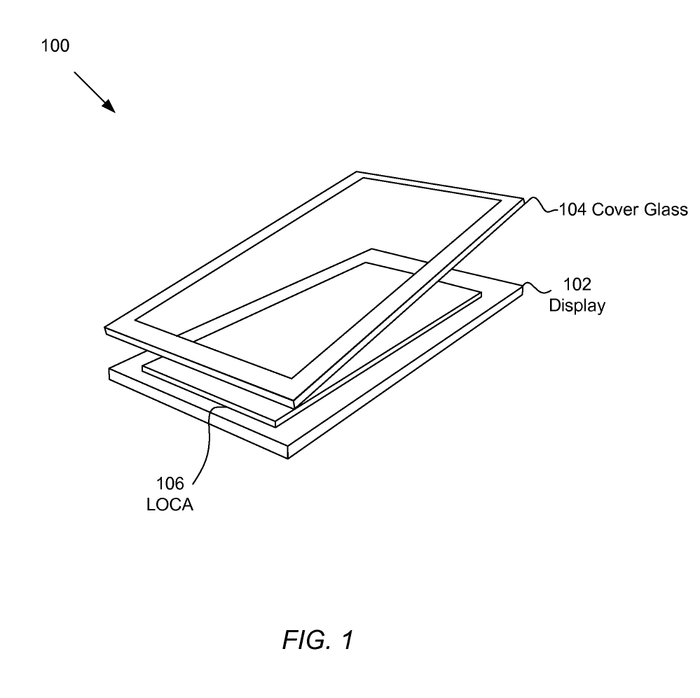

FIG. 1 is an exploded view of a lamination assembly 100. The lamination assembly 100 can include a first substrate 102, a second substrate 104 and an adhesive 106 disposed over either substrate. In the exemplary lamination assembly 100 of FIG. 1, the adhesive 106 is disposed over the first substrate 102. The substrates 102, 104 can be formed from any rigid, semi-rigid or flexible material. In one embodiment, a substrate can be optically transparent, such as glass or a substantially clear polymer. In another embodiment, a substrate can be a part of a larger assembly such as a glass portion of a display such as a liquid crystal display.

When the lamination assembly 100 includes a display, such as a liquid crystal display, the first substrate 102 can include the liquid crystal display and the second substrate 104 can include a cover glass. In the discussion herein, the term cover glass can be used when describing the second substrate and the term display can be used when describing the first substrate to help illustrate more clearly a relationship between the first and the second substrates. The selected terminology is not meant to be limiting.

When laminating the cover glass 104 to the display 102, the adhesive selected should be relatively clear so as not to occlude the view of the display 102 though the cover glass 104. In one embodiment, the adhesive 106 can be a liquid optically clear adhesive (LOCA).

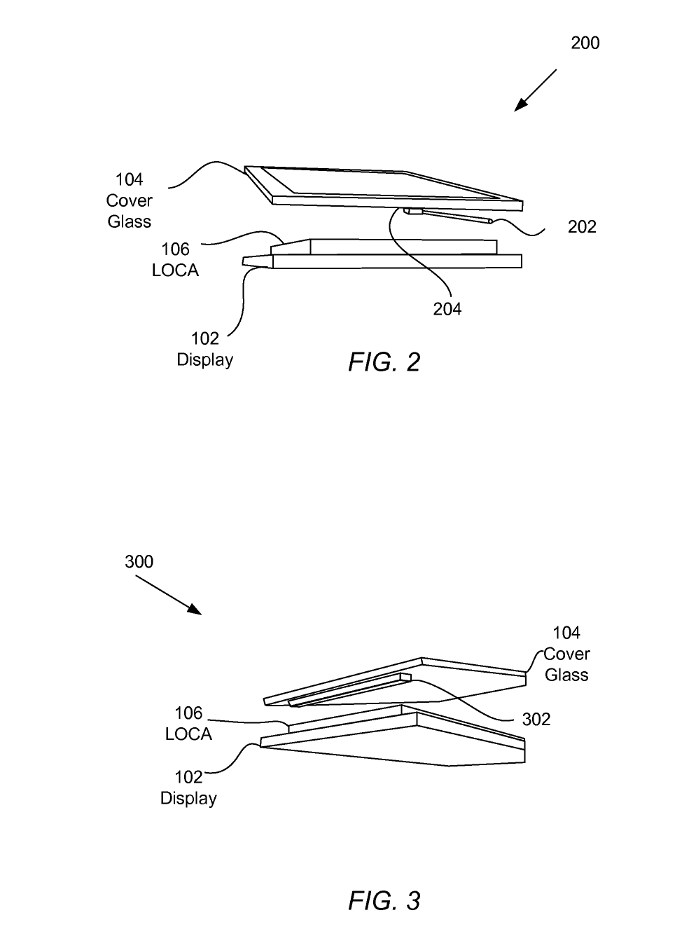

FIG. 2 shows an exploded view of one embodiment of a lamination assembly 200 configured to control an initial LOCA contact area. Lamination assembly 200 can include substrates such as display 102 and cover glass 104. A uniform layer of LOCA 106 can be disposed over the display 102. In one embodiment, a separate application of LOCA applied by applicator 202 can be disposed near one edge of the cover glass 104. In the embodiment shown in FIG. 2, the separate LOCA application can be applied near region 204, on the side of the cover glass 104 that is facing toward LOCA 106. In one embodiment, the additional LOCA can be formed from a single drop of LOCA. The additional LOCA can form a raised area or “bump” of LOCA that can make initial contact with LOCA 106 as the cover glass 104 is positioned near display 102 to begin to form a bond between cover glass 104 and display 102. In one embodiment, the additional LOCA at region 204 can pre-wet the cover glass 104. In one embodiment, the initial contact provided by additional LOCA in region 204 can help reduce and/or eliminate bubbles in a lamination area between the cover glass 104 and display 102.

In order to begin a lamination or bonding process, the edge of the cover glass 104 including the additional LOCA region 204 is held substantially parallel to one edge of the display 102. The cover glass 104 and display 102 can be positioned proximate to each other such that the additional LOCA in region 204 is brought into direct contact with LOCA 106. After initial LOCA contact is made, the edge of the cover glass remote from additional LOCA region 204 can be moved relative to the display 102 such that the cover glass 104 can be made parallel to the display 102.

FIG. 3 shows an exploded view of another embodiment of a lamination assembly 300 configured to control an initial LOCA contact area. Lamination assembly 300 can include substrates such as display 102 and cover glass 104. In this embodiment, a uniform layer of LOCA 106 can be disposed over display 102. A strip of additional LOCA 302 can be applied to the cover glass 104 to form the initial LOCA contact area. In one embodiment, the strip of LOCA 302 can be disposed near one edge of the cover glass 104, on the side of the cover glass 104 that is facing the LOCA 106. In contrast to the bump of LOCA described in FIG. 2, initial contact area can be expanded to a line along one edge of the cover glass 104. The strip of LOCA 302 can act as a single initial contact area when one edge of the cover glass 104 including the LOCA strip 302 is positioned substantially parallel to one edge of the display 102 and the LOCA strip 302 is positioned to be facing the uniform LOCA layer 106. The lamination (bonding) process for lamination assembly 300 can be substantially similar to the lamination process described above in conjunction with FIG. 2.

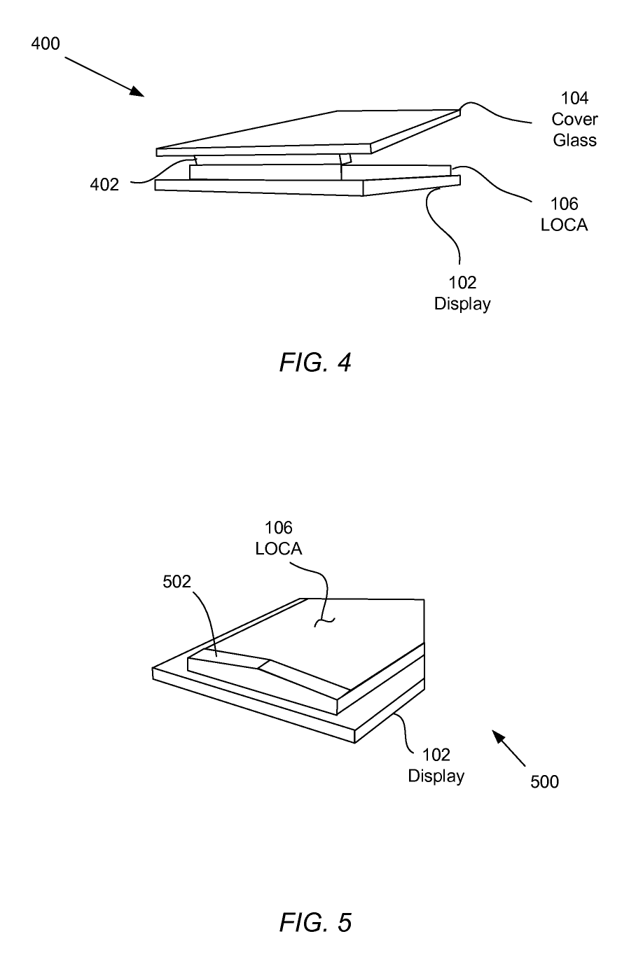

FIG. 4 shows yet another embodiment of a lamination assembly 400 configured to control an initial LOCA contact area. Lamination assembly 400 can include substrates such as display 102 and cover glass 104. In this embodiment, the initial contact area can be formed by applying additional LOCA to a region between the LOCA 106 and the cover glass 104 at relatively the same time. For example, cover glass 104 can be positioned near display 102 and LOCA 106 as shown. Additional LOCA 402 can be applied to a region near one edge of cover glass 104 and one edge of LOCA 106 such that LOCA 402 is applied to both surfaces contemporaneously. The lamination (bonding) process for lamination assembly 400 can be substantially similar to the lamination process described above in conjunction with FIG. 2.

FIG. 5 shows still yet another embodiment of a lamination assembly 500 configured to control an initial LOCA contact area. Lamination assembly 500 can be a simplified view showing only one substrate. In one embodiment, the one substrate can be the display 102. A uniform layer of LOCA can be disposed over display 102. Additional LOCA 502 can be applied in over existing LOCA 106 to form an initial contact area. As shown in FIG. 5, additional LOCA can be disposed proximate to one edge of the LOCA 106. When the additional LOCA 502 is disposed over LOCA 106, the additional LOCA 502 can form the initial contact area by standing taller than the uniform layer of LOCA 106. In one embodiment, the additional LOCA 502 can be 20% to 30% taller than the uniform layer of LOCA 106. The bonding process for lamination assembly 500 can be substantially similar to the lamination process described above in conjunction with FIG. 2.

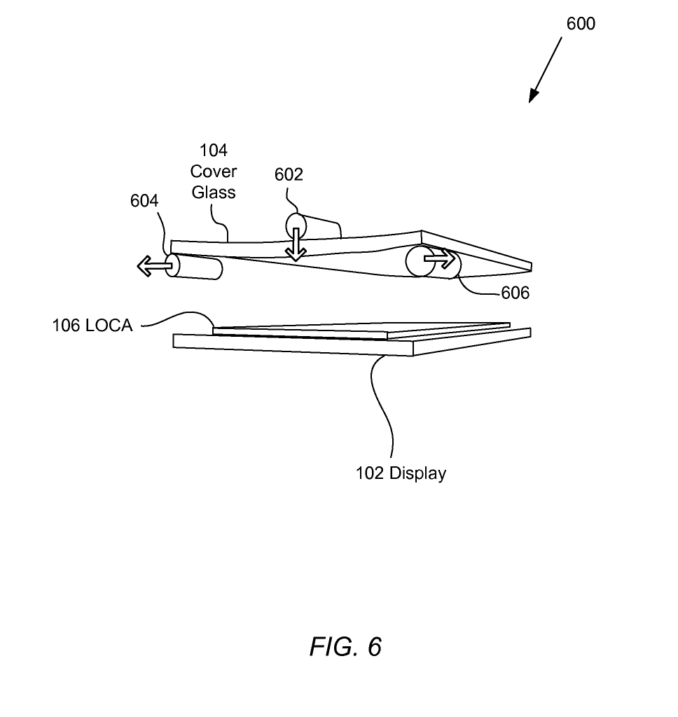

FIG. 6 shows still another embodiment of a lamination assembly 600. Lamination assembly 600 can include substrates such as display 102 and cover glass 104. As before, one substrate can receive a uniform layer of LOCA 106. In this embodiment, the display 102 can receive the LOCA 106. Cover glass 104 can be deformed slightly to form an initial contact area.

In one embodiment the initial contact area can be formed by exerting a pressure with a pin 602 in a downward direction toward LOCA 106 while support rollers 604 and 606 can support cover glass 104 allowing a deformation to form in the cover glass 104. (Note that FIG. 6 is meant to be illustrative in nature and not a precise, scaled apparatus drawing). In one embodiment, the initial contact area can be in the form of a line as can be determined by the shape of pin 602. After initial contact area is formed, cover glass 104 can be placed in contact with LOCA 106, particularly in the initial contact area. After initial contact with LOCA 106 is made, rollers 604 and 606 can move away from cover glass 104 allowing the entire cover glass to contact LOCA 106.

Another approach to prevent bubble or void inclusion in the lamination area is to treat at least a portion of a surface of at least one substrate to improve wettability of the LOCA. Improved wettability of a substrate surface can enable improved flow of LOCA between the substrates involved in the lamination assembly. In one embodiment, an entire substrate surface need not be treated, but rather just a limited region. This limited region can be analogous to the initial contact area described in FIGS. 2-6 because this limited region can also be the region where initial contact can be made with the LOCA 106.

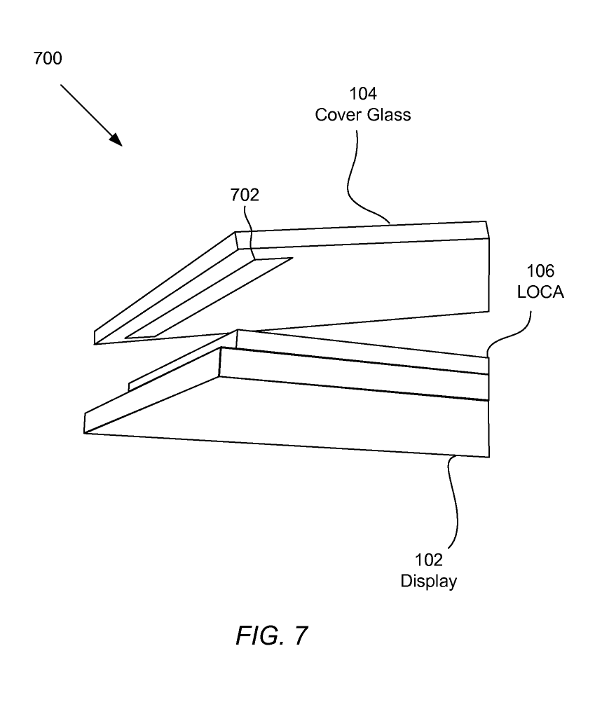

FIG. 7 shows an exploded view of a lamination assembly 700 configured to receive a surface treatment to improve wettability of LOCA. As described above, LOCA can flow better in areas of improved wettability and lessen the formation of voids and/or bubbles in the lamination area. The lamination assembly 700 can include substrates such as a display 102 and a cover glass 104. LOCA 106 can be disposed on one of the substrates; LOCA is disposed over display 102 in this exemplary assembly. Region 702 is a region located on the substrate not including the LOCA 106; region 702 is shown on cover glass 104 in this example.

Region 702 can be subjected to a plasma surface treatment to increase wettability in the area of the treatment. In one embodiment, region 702 can be treated with an inert gas plasma bombardment. Inert gases used to form plasmas can be noble gases such as helium, neon, argon and xenon. Inert gases can also include other gases that can be mostly non-reactive in a non-plasma state such as nitrogen. Treating region 702 with an inert gas plasma can increase wettability by increasing the surface energy of the substrate, particularly in region 702.

In another embodiment, region 702 can be treated with an oxygen plasma. Oxygen plasma can remove contaminants and dirt from region 702. Contaminants and dirt can cause poor wettability and low surface energy. Thus, treating region 702 with an oxygen plasma can increase wettability and improve lamination.

In yet another embodiment, an additional component can be introduced to the region 702. One example of an additional component is a hydrophilic monolayer that can be deposited on to or evaporated on to region 702. A hydrophilic monolayer can be a very thin layer that can increase wettability by causing the surface of the substrate in region 702 to become more hydrophilic. In another embodiment, a primer can be applied to region 702. One example of a primer can be LOCA particles mixed with a solvent such as either Ethanol or Methanol. The primer can be easily applied and can also have relatively lower cost compared to other alternatives such as disposing a hydrophilic monolayer. After region 702 is acted upon, as described above, bonding the first substrate to the second substrate can be performed as described in FIG. 2.

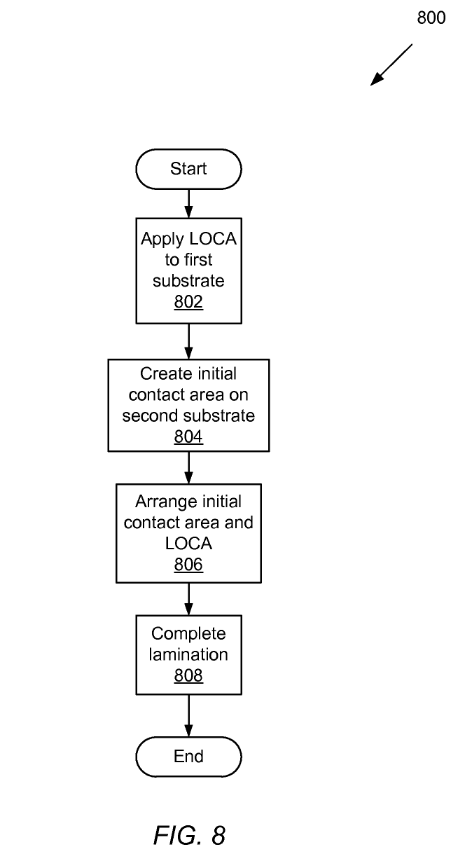

FIG. 8 is a flow chart 800 of method steps for laminating a first substrate to a second substrate in accordance with one embodiment described in the specification. Persons skilled in the art will understand that any system configured to perform the method steps in any order is within the scope of this description. The method can begin in step 802 where a uniform layer of an adhesive is applied to a first substrate. In one embodiment, the adhesive can be LOCA 106 and can be applied on the display 102. In step 804, an initial contact area can be formed on a second substrate. In one embodiment, the initial contact area can be formed with LOCA, (separate from the LOCA 106 used in step 802), on cover glass 104. In step 806, the initial contact area can be placed in direct contact with a portion of the uniform layer of LOCA 106. In step 808, the lamination between the first substrate and the second substrate can be completed by, for example, arranging the first substrate to be substantially parallel to the second substrate.

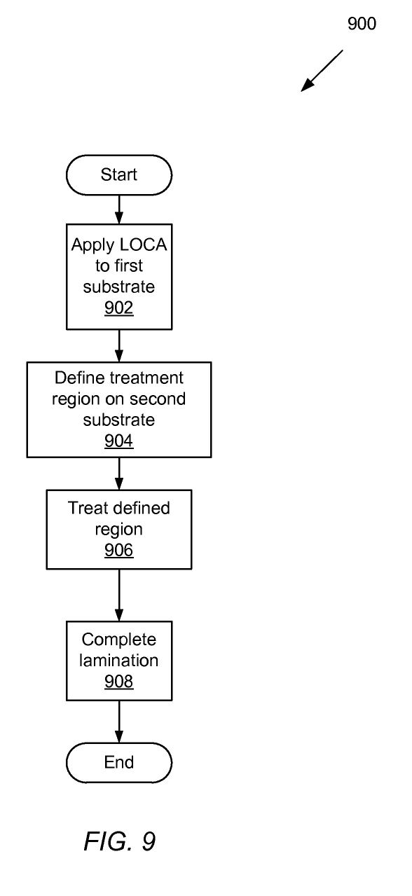

FIG. 9 is a flow chart 900 of another embodiment of method steps for laminating a first substrate to a second substrate in accordance with one embodiment described in the specification. The method begins in step 902 where a uniform layer of an adhesive can be applied to the first substrate. In step 904, a treatment region is defined on the second substrate. In one embodiment, the treatment region can correspond to an initial contact area similar to region 702 described in FIG. 7. In step 906, the defined region is treated to improve wettability. In one embodiment, for example, the defined region can bombarded with an inert gas plasma. In step 908 the lamination between the first substrate and the second substrate can be completed by, for example, arranging the first substrate to be substantially parallel to the second substrate.

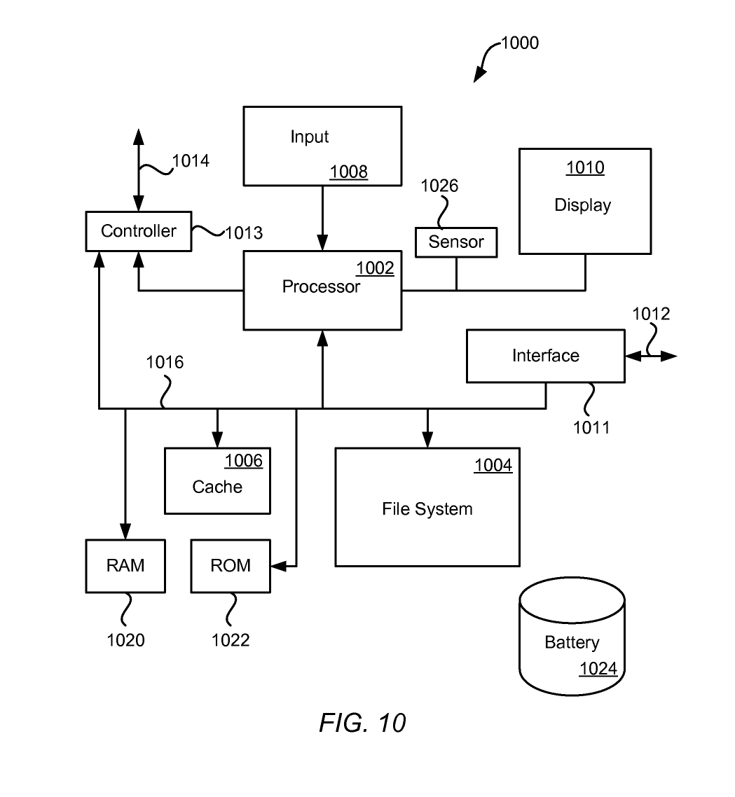

FIG. 10 is a block diagram of an electronic device suitable for controlling some of the processes in the described embodiment. Electronic device 1000 can illustrate circuitry of a representative computing device. Electronic device 1000 can include a processor 1002 that pertains to a microprocessor or controller for controlling the overall operation of electronic device 1000. Electronic device 1000 can include instruction data pertaining to manufacturing instructions in a file system 1004 and a cache 1006. File system 1004 can be a storage disk or a plurality of disks. In some embodiments, file system 1004 can be flash memory, semiconductor (solid state) memory or the like. The file system 1004 can typically provide high capacity storage capability for the electronic device 1000. However, since the access time to the file system 1004 can be relatively slow (especially if file system 1004 includes a mechanical disk drive), the electronic device 1000 can also include cache 1006. The cache 1006 can include, for example, Random-Access Memory (RAM) provided by semiconductor memory. The relative access time to the cache 1006 can substantially shorter than for the file system 1004. However, cache 1006 may not have the large storage capacity of file system 1004. Further, file system 1004, when active, can consume more power than cache 1006. Power consumption often can be a concern when the electronic device 1000 is a portable device that is powered by battery 1024. The electronic device 1000 can also include a RAM 1020 and a Read-Only Memory (ROM) 1022. The ROM 1022 can store programs, utilities or processes to be executed in a non-volatile manner. The RAM 1020 can provide volatile data storage, such as for cache 1006.

Electronic device 1000 can also include user input device 1008 that allows a user of the electronic device 1000 to interact with the electronic device 1000. For example, user input device 1008 can take a variety of forms, such as a button, keypad, dial, touch screen, audio input interface, visual/image capture input interface, input in the form of sensor data, etc. Still further, electronic device 1000 can include a display 1010 (screen display) that can be controlled by processor 1002 to display information to the user. Data bus 1016 can facilitate data transfer between at least file system 1004, cache 1006, processor 1002, and controller 1013. Controller 1013 can be used to interface with and control different manufacturing equipment through equipment control bus 1014. For example, control bus 1014 can be used to control a computer numerical control (CNC) mill, a press, an injection molding machine or other such equipment. For example, processor 1002, upon a certain manufacturing event occurring, can supply instructions to control manufacturing equipment through controller 1013 and control bus 1014. Such instructions can be stored in file system 1004, RAM 1020, ROM 1022 or cache 1006.

Electronic device 1000 can also include a network/bus interface 1011 that couples to data link 1012. Data link 1012 can allow electronic device 1000 to couple to a host computer or to accessory devices. The data link 1012 can be provided over a wired connection or a wireless connection. In the case of a wireless connection, network/bus interface 1011 can include a wireless transceiver. Sensor 1026 can take the form of circuitry for detecting any number of stimuli. For example, sensor 1026 can include any number of sensors for monitoring a manufacturing operation such as for example a Hall Effect sensor responsive to external magnetic field, an audio sensor, a light sensor such as a photometer, computer vision sensor to detect clarity, a temperature sensor to monitor a molding process and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for laminating a first substrate to a second substrate with liquid optically clear adhesive (LOCA), the method comprising:
applying a uniform layer of LOCA on the first substrate;
creating only one initial contact region with LOCA dispensed separately from the uniform layer of LOCA only on one proximal edge of the second substrate;
placing the initial contact region of LOCA on the second substrate in direct contact with the uniform LOCA layer on the first substrate; and,
moving a distal edge of the second substrate toward the first substrate until the first and the second substrates are substantially parallel.

2. The method of claim 1, wherein the initial contact region of LOCA is formed by dispensing a predefined amount of LOCA proximate to the proximal edge of the second substrate.

3. The method of claim 1, wherein the initial contact point of LOCA is formed by dispensing a line of LOCA along the proximal edge of the second substrate.

4. The method of claim 1, wherein the first substrate is a cover glass.

5. The method of claim 4, wherein the second substrate is at least a portion of a display.

6. The method of claim 1, wherein the placing further comprises aligning the one proximal edge of the second substrate with one edge of the first substrate.

7. A display assembly comprising:
a first substrate with a first surface;
a board assembly, the board assembly comprising a liquid crystal display, wherein the board assembly is disposed under the first substrate;
a layer of a liquid optically clear adhesive (LOCA) disposed on the liquid crystal display; and,
a single contact region of LOCA disposed on the first surface of the first substrate, wherein the first surface is positioned facing towards the liquid crystal display and wherein the first substrate is laminated to the liquid crystal display by first placing only the single contact region of LOCA onto the layer of LOCA disposed on the liquid crystal display and subsequently arranging the rest of the first surface of the first substrate in contact with the LOCA on the liquid crystal display.

8. The display assembly of claim 7, wherein the first substrate is a cover glass.

9. The display assembly of claim 7, wherein the first substrate is separate from the board assembly when the single contact region of LOCA is disposed on the first substrate.

10. The display assembly of claim 9, wherein the single contact region of LOCA is in the form of a line formed along one edge of the first substrate.

11. The display assembly of claim 9, wherein the single contact region of LOCA is in the form of a droplet.

12. The display assembly of claim 7, wherein the single contract region of LOCA is in the form of only one line disposed on the first surface of the first substrate and the liquid crystal display contemporaneously.

13. A method for laminating a cover glass to a display with liquid optically clear adhesive (LOCA), the method comprising:
applying a uniform layer of LOCA on the display;
creating only one initial contact region with LOCA dispensed separately from the uniform layer of LOCA only on one proximal edge of the display, disposed over the uniform layer of LOCA;
placing a proximal edge of the cover glass in direct contact with the initial contact region of LOCA uniform on the first substrate; and,
moving the distal edge of the cover glass toward the display until the display and the cover glass are substantially parallel.

14. The method of claim 13, wherein the initial contact region is disposed within a predetermined distance from the edge of the uniform layer and is a predetermined height greater than the height of the uniform layer.

15. The method of claim 14, wherein the predetermined height is within 20 to 30 percent of the height of the uniform layer.

16. Non-transient computer readable medium for storing computer code executable by a processor in a computer system for forming laminating a first substrate to a second substrate, the computer readable medium comprising:
computer code for applying a uniform layer of optically clear adhesive (LOCA) onto a first substrate;
computer code for forming an initial contact region with LOCA, separate from the LOCA on the first substrate, onto one edge of the second substrate;
computer code for aligning the initial contact region on the second substrate with the uniform LOCA layer on the first substrate such that the initial contact region is in direct contact with the uniform LOCA layer; and,
computer code for aligning the first substrate and the second substrate such that they are substantially parallel.

17. The non-transient computer readable medium as recited in claim 16, wherein the computer code for forming an initial contact region further comprises computer code for dispensing a predefined amount of LOCA proximate to one edge of the second substrate.

18. The non-transient computer readable medium as recited in claim 16, wherein the computer code for forming an initial contact region further comprises computer code for dispensing a line of LOCA proximate to one edge of the second substrate.

19. The non-transient computer readable medium as recited in claim 18, wherein the first substrate comprises a cover glass.

20. The non-transient computer readable medium as recited in claim 19, wherein the second substrate comprises at least a portion of a display.
